(19) United States
(12) Patent Application Publication
(10) Pub. No.: US 2025/0037007 A1
(43) Pub. Date: Jan. 30, 2025

(54) JOINT TRAINING ALGORITHM AND HYPER-PARAMETER OPTIMIZATION IN FEDERATED LEARNING SYSTEMS

(71) Applicants: International Business Machines Corporation, Armonk, NY (US); Rensselaer Polytechnic Institute, Troy, NY (US)

(72) Inventors: Theodoros Salonidis, Wayne, PA (US); Md Ibrahim Ibne Alam, Troy, NY (US); Koushik Kar, Waterford, NY (US); Horst Cornelius Samulowitz, Armonk, NY (US)

(21) Appl. No.: 18/227,394

(22) Filed: Jul. 28, 2023

(51) Int. Cl. G06N 20/00

(52) U.S. Cl. CPC G06N 20/00

(57) ABSTRACT

For at least a first two iterations: for candidate training algorithms, obtain from clients, a score corresponding to a best hyperparameter, based on a fraction of available training data; for the algorithms, aggregate the scores and update a projected score for each of the algorithms; and increase the fraction of available training data to be used in a subsequent one of the at least a first two iterations or a first one of a plurality of subsequent iterations. For the subsequent iterations: for a best-performing subset of the algorithms, obtain from the clients, an updated best hyperparameter and corresponding score, based on a further increased fraction of available training data as compared to a final iteration of at least first two iterations or a previous one of the subsequent iterations; and for the best-performing subset, aggregate the obtained updated scores and further update a projected score for each subset member.

### BACKGROUND

The present invention relates to the electrical, electronic and computer arts, and more specifically, to machine learning systems, in the context of federated learning.

Federated learning (FL) is a distributed learning framework that enables training a model from decentralized data located at client sites, without the data ever leaving the clients. Compared to a centralized model, in which training requires all the data to be transmitted to and stored in a central location (e.g., a data center), FL has the benefits of preserving data privacy while avoiding transmission of large volumes of raw data from the client sites.

FL has two pertinent challenges: first, the data across clients can be highly heterogeneous. Second, the communication overhead can be prohibitive during training as model parameters are exchanged in multiple global rounds between the clients and an aggregation server. Therefore there has been significant research effort on FL techniques that reduce communication overhead during model training. Such techniques typically assume that the clients agree on a common algorithm and hyperparameters (HPs) before training occurs; i.e., do not provide AutoML (automated machine learning) capabilities.

### SUMMARY

Principles of the invention provide techniques for a joint training algorithm and hyper-parameter optimization in federated learning systems. In one aspect, an exemplary method includes the steps of for at least a first two iterations: for a plurality of candidate training algorithms, obtaining, at a federated learning aggregator, from each of a plurality of federated learning clients, a score corresponding to a best hyperparameter, based on a fraction of available training data; for the plurality of candidate algorithms, the federated learning aggregator aggregating the obtained scores and updating a projected score for each of the candidate training algorithms; and increasing the fraction of available training data to be used in a subsequent one of the at least a first two iterations or a first one of a plurality of subsequent iterations. The method further includes, for the plurality of subsequent iterations: for a best-performing subset of the plurality of candidate training algorithms, obtaining, at the federated learning aggregator, from each of the plurality of federated learning clients, an updated best hyperparameter and an updated corresponding score, based on a further increased fraction of available training data as compared respectively to a final iteration of at least first two iterations or a previous one of the subsequent iterations; and for the best-performing subset of the plurality of candidate algorithms, the federated learning aggregator aggregating the obtained updated scores and further updating a projected score for each of the best-performing subset of the candidate training algorithms.

In another aspect, an exemplary computer program product is provided for implementing a federated learning aggregator on a computer. The computer program product includes a computer readable storage medium having stored thereon: first program instructions executable by the computer to cause the computer to, for at least a first two iterations: for a plurality of candidate training algorithms, obtaining, at a federated learning aggregator, from each of a plurality of federated learning clients, a score corresponding to a best hyperparameter, based on a fraction of available training data; for the plurality of candidate algorithms, the federated learning aggregator aggregating the obtained scores and updating a projected score for each of the candidate training algorithms; and increasing the fraction of available training data to be used in a subsequent one of the at least a first two iterations or a first one of a plurality of subsequent iterations. Also included are second program instructions executable by the computer to cause the computer to, for the plurality of subsequent iterations: for a best-performing subset of the plurality of candidate training algorithms, obtaining, at the federated learning aggregator, from each of the plurality of federated learning clients, an updated best hyperparameter and an updated corresponding score, based on a further increased fraction of available training data as compared respectively to a final iteration of at least first two iterations or a previous one of the subsequent iterations; and for the best-performing subset of the plurality of candidate algorithms, the federated learning aggregator aggregating the obtained updated scores and further updating a projected score for each of the best-performing subset of the candidate training algorithms.

In still another aspect, a federated learning aggregator includes: a memory; and at least one processor, coupled to the memory. The at least one processor is operative to: for at least a first two iterations: for a plurality of candidate training algorithms, obtain from each of a plurality of federated learning clients, a score corresponding to a best hyperparameter, based on a fraction of available training data; for the plurality of candidate algorithms, aggregate the obtained scores and update a projected score for each of the candidate training algorithms; and increase the fraction of available training data to be used in a subsequent one of the at least a first two iterations or a first one of a plurality of subsequent iterations. The at least one processor is further operative to: for the plurality of subsequent iterations: for a best-performing subset of the plurality of candidate training algorithms, obtain, from each of the plurality of federated learning clients, an updated best hyperparameter and an updated corresponding score, based on a further increased fraction of available training data as compared respectively to a final iteration of at least first two iterations or a previous one of the subsequent iterations; and for the best-performing subset of the plurality of candidate algorithms, aggregate the obtained updated scores and further update a projected score for each of the best-performing subset of the candidate training algorithms.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improves the technological process of computerized machine learning, in the context of federated learning, by saving communication costs as compared to prior art techniques, using a “single-shot” Combined Algorithm Selection and hyperparameter optimization (HPO) (CASH);
provides a general framework for CASH in federated learning;
can be applied to all types of machine learning (ML) models, including tree-based models;
can be applied to generic FL algorithms, not limited to SGD-based algorithms (SGD=stochastic gradient descent);
Can tolerate non-iid (independent and identically distributed) data.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a federated learning system, according to an aspect of the invention;

FIG. 2 depicts a first algorithm, according to an aspect of the invention;

FIG. 3 depicts a second algorithm, according to an aspect of the invention;

FIGS. 4 and 5 present tables showing exemplary result achieved with embodiments of the invention;

FIGS. 6, 7, 8, 9, 10, and 11 present graphs showing exemplary result achieved with embodiments of the invention; and

FIG. 12 depicts a computing environment according to an embodiment of the present invention.

### DETAILED DESCRIPTION

As noted, FL is a distributed learning framework that enables training a model from decentralized data located at client sites, without the data ever leaving the clients. The problem of HyperParameter Optimization (HPO) in FL is a pertinent problem as the choice of HPs can significantly affect FL system performance. The FL setting poses unique challenges in addressing HPO, due to non-iid (independent and identically distributed) data, limited processing power at clients, and function evaluations for an HP set being much more communication and computation intensive than the centralized setting because they require FL training. Solving the algorithm selection along with HPO (popularly known as CASH) in an FL setting inherits the aforementioned challenges of HPO in FL and adds the additional layer of complexity of algorithm selection, where different algorithms have different performance as well as different HP sets. One or more embodiments advantageously provide a way to solve the CASH problem for an FL setting without performing any FL in the solution process (i.e., only using FL after solving CASH). Heretofore, the CASH problem has only been addressed in the centralized setting, and most approaches treat it as a more complex HPO problem that merges the HPs of all algorithms and adds the algorithm type as a new HP. Extending the HPO algorithms to use this approach would not be adequate due to the explosion on HP dimensionality and computation complexity; in addition it is not evident how to aggregate these new CASH HPs to an single optimal HP set.

One or more embodiments advantageously provide “FLASH,” a framework which addresses for the first time the central AutoML problem of Combined Algorithm Selection and HyperParameter (HP) Optimization (CASH) in the context of Federated Learning (FL). To limit training cost, embodiments of FLASH incrementally adapt the set of algorithms to train based on their projected loss rates, while supporting decentralized (federated) implementation of the embedded hyper-parameter optimization (HPO), model selection and loss calculation problems. A theoretical analysis of the training and validation loss under FLASH is provided, as well as a tradeoff with the training cost measured as the data wasted in training sub-optimal algorithms. The bounds depend on the degree of dissimilarity between the datasets of the clients, a result of FL restriction that client datasets remain private. Through extensive experimental investigation on several datasets, three exemplary variants of FLASH are evaluated. We have found that exemplary embodiments of FLASH perform close to centralized CASH methods.

Embodiments of FLASH provide a framework which solves the CASH problem in an FL setting by viewing it as bi-level optimization problem: the algorithm selection problem being solved at the outer level requires solving the embedded HPO problem at the inner level. Embodiments of FLASH solve the algorithm selection problem using a multi-fidelity approach, where, for each algorithm, the inner level HPO method (referred to herein as FL-HPO) runs on increasing subsets of the clients' data, providing data increments to a subset of best performing algorithms according to a projected loss curve and subject to a tolerance threshold. This avoids wasting training resources on poorly performing algorithms. We have evaluated embodiments of the FLASH framework under three FL-HPO methods: Local Best Model (LBM), Local K-Best Model (LKBM), and Regression based Model (RM). These FL-HPO approaches allow the clients to run HPO separately on their private data, but differ in how the results from the individual clients are aggregated at the central server and further re-validated at the clients, before the final HP choice is determined for the algorithm choice made at the outer level algorithm selection problem. Instead of expensive FL training, each HP configuration is evaluated using an approximation metric modeled as a linear combination of the clients' local loss functions.

This in turn enables embodiments of FLASH to reduce communication and computation overhead by first performing a CASH search for the best algorithm-hyperparameter (Alg-HP) configuration in only a few rounds of communication between the clients and the central server, and then performing a single FL training to reach the final model for this configuration.

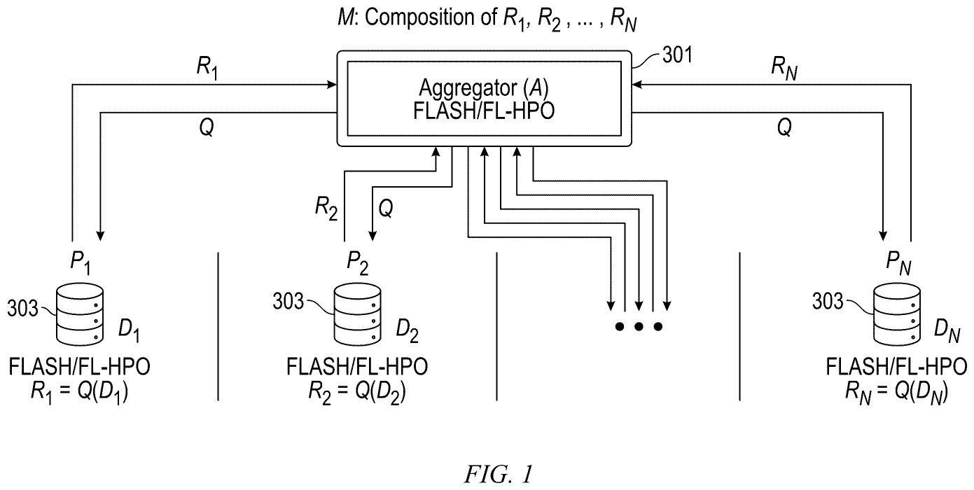

FIG. 1 shows an aggregator 301 with a plurality of clients 303 labeled D₁, D₂, . . . , D_{N}, cooperatively implementing aspects of FLASH and FL-HPO as disclosed herein. The FL system of FIG. 1 thus includes the aggregator server 301 and multiple clients 303 who seek to train a global model based on their private local datasets. After performing embodiments of FLASH, and obtaining the best algorithm-hyperparameter configuration, the aggregator server monitors the federated learning process, issues queries Q to clients, collects responses R₁, R₂, R_{N} from the clients, and aggregates the collected responses to update the global model M.

Each Q is a query issued by the aggregator to learn a global predictive model M. Given the current weight (model parameter), the query asks for gradients and asks for new model parameters. The query further asks for information about a specific label (class), such as counts and the like.

Each P (client/participant) responds to aggregator queries based on its local dataset Dᵢ.

Presented herein is a theoretical analysis of the worst-case loss performance and the wasted training cost measured as the data allocated for training sub-optimal algorithms. The performance bounds are expressed in terms of the dissimilarity between the client dataset distributions and other key parameters. Experiments discussed herein investigate these trade-offs and shows that embodiments of FLASH can achieve a performance that is close to that of centralized CASH.

Thus, embodiments of FLASH provide a framework that solves for the first time the CASH problem in a FL setting by decomposing it into algorithm selection (outer level) and FL-HPO (inner level) problems. Embodiments of FLASH minimize communication and computation overhead during CASH search using a multi-fidelity incremental data approach at the algorithm selection level and by avoiding expensive FL training-based evaluations at the FL-HPO level. Advantageously, in one or more embodiments, only a single FL training is needed for the Alg-HP configuration found during CASH search.

A theoretical analysis is provided of the convergence and worst-case loss performance of three exemplary FLASH embodiments, and the wasted training cost measured as the data allocated for training sub-optimal algorithms. These performance bounds are expressed in terms of the dissimilarity between the client dataset distributions and other pertinent parameters.

Numerical evaluation of FLASH is provided on eight large data sets with seven algorithm choices, for three exemplary FL-HPO variants and several baseline approaches. The accuracy and training cost for these variants is compared, and the performance effects of some of the parameter choices and options that FLASH provides are evaluated.

### Cash Formulation in FL

Consider first defining the CASH problem in an FL setting. Similar to the standard CASH problem considered in a centralized setting, a set of algorithms are given A=(A⁽¹⁾, . . . , A^{(J)}), where each algorithm A^{(j)} is associated with hyperparameters (HPs) that belong to domain Λ^{(j)}. Each algorithm choice A^{(j)} and HP setting λ∈Λ^{(j)}, compactly written as A_{λ}^{(j)}, is associated with a model class W_{λ}^{(j)}, from which a model (parameter vector) w∈W_{λ}^{(j)} are chosen so as to minimize a predictive loss function [symbol] (w, [symbol] ′) over a validation dataset [symbol] ′.

In an FL setting, the training dataset [symbol] can be partitioned into several subsets [symbol] , i∈ [symbol] that are owned individually by a set of N=| [symbol] | clients. Thus [symbol] = [symbol] . Assume that [symbol] is private to client i, and cannot be shared or aggregated due to privacy or complexity reasons. Given an algorithm and HP choice, A_{λ}^{(j)}, an FL function [symbol] aims to determine a model w using the training dataset, [symbol] (A_{λ}^{(j)}, ∪ᵢ [symbol] )→w∈W_{λ}^{(j)}, where the training dataset [symbol] is written as ∪ᵢ [symbol] to emphasize its distributed (partitioned) nature. Usually, w is chosen to minimize the training error, modeled with the given loss function [symbol] but computed over the training dataset [symbol] . That is, the FL function [symbol] typically aims to minimize [symbol] (w, ∪ᵢ [symbol] ) over w∈W_{λ}^{(j)}, using iterative methods that involve local model training at the individual clients (using their private datasets) and sharing information on models and their accuracies (but not data) with a central aggregator.

Although it is not necessary for the validity of the analysis or results, for ease of exposition, assume that the validation dataset [symbol] ′ is partitioned across the clients as well. Thus [symbol] ′=∪ᵢ [symbol] ′, where [symbol] ′ is the validation dataset of client i. Then, given the underlying FL function [symbol] for finding the model (for any Alg-HP setting), the CASH problem for FL involves finding A*_{λ*} that minimizes a global loss function, computed as the aggregation of loss functions at the clients (over their validation datasets):

$${A}_{λ *}^{*} = arg min {\sum }_{i} {α}_{i} ( ( {A}_{λ}^{( j )} , {⋃}_{i} {i}_{} ) , {i}_{′}^{} ) where {A}^{( j )} ∈ , λ ∈ {Λ}^{( j )} . \qquad ( Eq . l )$$

In the above, αᵢ are appropriately defined client weights, such as αᵢ=1/N or αᵢ=| [symbol] / [symbol] |, and the FL function ( [symbol] ) also uses these weights for computing the loss in the training process.

### Flash Framework

Even in a centralized setting, solving the CASH problem of finding the best Alg-HP pair A*_{λ*} is computationally expensive due the large number (set) of Alg-HP combinations over which the loss function must be minimized. This is more complex (i.e., communication intensive) in an FL setting, as the loss evaluation for any specific A_{λ}^{(j)} requires solving the underlying FL (model training) problem that may take multiple (possibly many) rounds of communication between the clients and the central server. To address this complexity issue, FLASH adopts three broad principles or approximations, as listed below. These approximations introduce a degree of sub-optimality in the solving the CASH problem in FL, which is quantified through theoretical analysis in the next section.

Firstly, in FLASH the global loss for any A_{λ}^{(j)} setting is computed by aggregating the losses computed at the clients on their individual datasets. In other words, in comparing the Alg-HP settings in FLASH, the loss function in FLASH is calculated as:

$${\sum }_{i} {α}_{i} ( ( {A}_{λ}^{( j )} , {i}_{} ) , {i}_{′}^{} ) . \qquad ( Eq . 2 )$$

Note that ∪ᵢ [symbol] within the model training function [symbol] in (Eq. 1) is replaced by [symbol] in (Eq. 2). This implies that in FLASH, model training (and therefore loss computation) happens locally in each client, avoiding the communication-intensive procedure of computing the global model through FL. This allows FLASH to compute the global loss function (albeit approximately), for a given A_{λ}^{(j)} and training dataset, in a single round of communication.

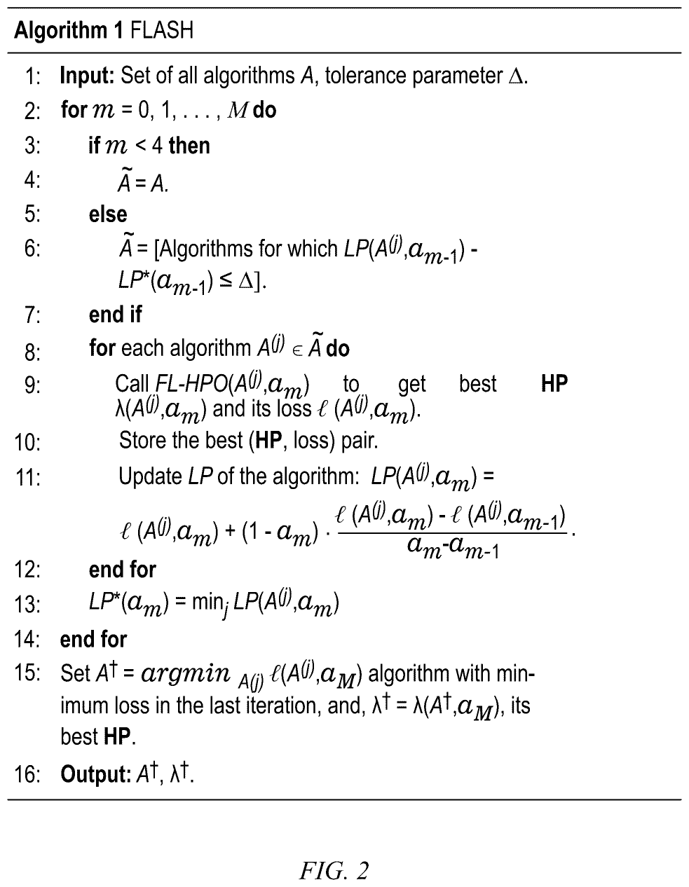

Secondly, FLASH divides up the CASH problem in FL into two levels (see Algorithm 1 in FIG. 2): the outer level (‘for’ loop in Steps 2-14) which involves finding [symbol] the optimal algorithm A^{(j)} ∈ [symbol] (for the best HP setting), and the inner level problem that requires finding the best HP λ ∈Λ^{(j)} for any given A^{(j)}. However, finding the best (global) HP λ for a given A^{(j)}, even for the separable loss function in (Eq. 2), can be computation and communication intensive in an FL setting. For this reason, FLASH approximates it using decentralized FL-HPO approaches (Step 9 of Algorithm 1, described later in this section) that work by aggregating the HPs (and their corresponding loss values) computed/validated separately by the clients on their individual datasets.

Finally, since training all algorithms on entire client datasets could be wasteful (particularly when the client datasets are large, or there are a large number of algorithm choices), FLASH allocates training data to the algorithms incrementally, focusing only the best performing algorithms at any time. More specifically, FLASH works in rounds, i.e., 0, 1, 2, . . . , M (Step 2 in Algorithm 1), and keeps a running set of best performing algorithms Ā ⊆ A that it updates after each round. In round m, FLASH evaluates the training loss on fraction aₘ of the data (randomly chosen) at each client (by calling Algorithm 2 in Step 9), where 0<a₀<a₁<. . . <a_{M}=1, and projects the loss curve to the entire data set. More precisely, denoting [symbol] (A^{(j)}, aₘ) as the loss rate for algorithm A^{(j)} calculated in round m by FLASH, the loss projection (LP) for A^{(j)} is computed by linearly extrapolating [symbol] (A^{(j)}, aₘ) from aₘ to a_{M}=1, i.e., LP(A^{(j)})= [symbol] (A^{(j)}, aₘ)+(1−aₘ)⋅ [symbol] ′(A^{(j)}, aₘ) (Step 11 of Algorithm 1). Here, [symbol] ′(A^{(j)}), aₘ) is an estimate of the derivative of the loss rate curve based on the loss rates calculated by FLASH so far, [symbol] (A^{(j)}, a′ₘ), m′≤m. Also, LP*(aₘ)=minⱼ LP(A^{(j)}, aₘ) is the minimum projected loss computed at step m for all A^{(j)} (Step 6 of Algorithm 1). Then, for a chosen tolerance factor Δ (an input parameter), in any round FLASH selects all algorithms (for training in the next round) whose projected loss is within Δ of the best projected loss in that round (Step 6 of Algorithm 1). Note that to calculate the loss projection (LP) for each algorithm at least two values (m=2) are needed. However, due to the small (fractional) datasets used in the initial steps, m=2 may lead to a very noisy loss projection. Hence, we have found that it is helpful, in one or more non-limiting exemplary embodiments, to go up to 3 iterations (m=3) to estimate the initial LP of all algorithms (Steps 3 to 4 of Algorithm 1) and start choosing algorithms (to which training data is to be allocated) from m=4.

Computing the loss function on fraction aₘ of the training dataset for any algorithm A^{(j)} requires finding the optimum HP λ∈Λ^{(j)} for that dataset. Since this dataset is spread across the clients, this optimization in done in a federated manner, by aggregating (at the central server) the HPs and corresponding losses by running per-client HPOs. This is referred to as FL-HPO in Algorithm 1 (Step 9), and is described below.

### Flash FL-HPO Algorithm

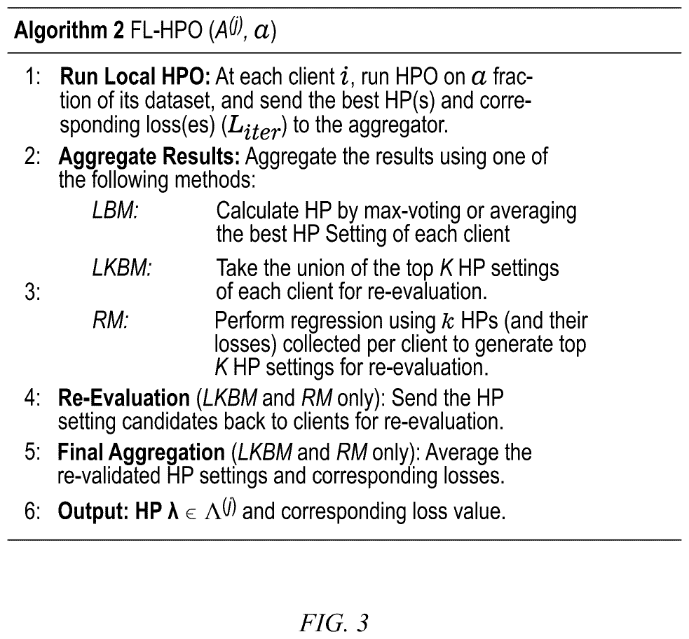

Our FL-HPO method is summarized by Algorithm 2 of FIG. 3. It provides a way to compute the best HP for a given algorithm A^{(j)} and data size fraction a in a decentralized manner and can be implemented easily in any FL platform, given the teachings herein. There are three exemplary variants of our FL-HPO method disclosed herein, called LBM, LKBM, and RM; a pertinent difference among them is how they aggregate local HPs computed by the clients to find a globally optimal HP.

Initially, when the FL-HPO method (Algorithm 2 of FIG. 3) is called, each client i creates a subset of its dataset by sampling a fraction a of its data-samples (Step 1 of Algorithm 2). Then it locally runs an HPO algorithm (e.g., using a known python library for hyperparameter optimization) on this subset for a given number of iterations (HPOᵢₜₑᵣ). Each iteration evaluates an HP on the subset using k-fold cross-validation and yields a loss value Lᵢₜₑᵣ. A set of HPs and their loss values explored by HPO is then communicated to the server by the client as (HP, loss) pairs. Then the server aggregates the TPs and yields a set of candidate global HPs using one of the three variants described as follows (Step 2 of Algorithm 2):

Local Best Model (LBM): In LBM, each client sends its best (HP, loss) pair to the server. The aggregator computes the global HP set by performing max-voting to categorical HP coordinates (ties broken randomly) and averaging the numerical HP coordinates across the clients' HP sets.

Local K-Best Model (LKBM): In LKBM, each client sends its K-best (HP, loss) pairs explored by its HPO to the server. Then the server sends these K×N HP pairs as candidate global HPs to all clients for evaluation (each client will evaluate the K-best HPs of the others).

Regression based Model (RM): In RM, each client sends all (HP, loss) pairs explored by its HPO to the server. Then the server uses all these pairs to train a regressor model (e.g., a known machine learning algorithm which combines the output of multiple decision trees to reach a single result). After training, the regressor model is used to compute the predicted losses for a large number of HP settings (generated randomly), and the top-10 performing ones are kept. These HPs form the global HP set that are sent to the clients for re-evaluation.

After the candidate set of global HP sets are determined (from Step 2 of Algorithm 2), these sets are sent to the clients for re-evaluation. The clients evaluate them using k-fold cross-validation on their data subsets and send back to the server the global HP sets and their corresponding loss values (Step 4 of Algorithm 2). Finally, the server averages the losses of each global HP set sent by the clients and selects the global HP set with the minimum average loss (Step 5 of Algorithm 2). It is to be noted that Steps 4 and 5 of Algorithm 2 are only executed for LKBM and RM variants, whereas the global best HP is found at step 3 of Algorithm 2 for the LBM variant. In other words, in LBM the HPs are computed by just combining the best HPs provided by the clients, i.e., the server does not send any HP(s) back to the clients for re-validation. This makes LBM simpler, but as we will see later in the Empirical Evaluation section, it results in a slightly worse performance then the other two variants.

### Theoretical Analysis

This section provides a theoretical analysis of the loss optimality and training cost of FLASH.

Preliminaries. Let [symbol] represent a dataset comprising of a fraction of the training data, and [symbol] the corresponding per-client datasets; from Algorithm 1, recall that a varies as a₀, a₁, . . . , a_{M}. For a given algorithm A^{(j)}, let [symbol] A^{(j)}, a) represent the true training loss for algorithm A^{(j)} when using a fraction of the data. Since this training loss depends on how the dataset [symbol] is chosen, the true training loss can be estimated by averaging over the losses computed over all possible datasets [symbol] , denoted by [symbol] ={ [symbol] ⊆ [symbol] , | [symbol] |=a| [symbol] |}. Therefore, from (Eq. 1), [symbol] (A^{(j)}, a) can be expressed as:

$$\underline{ℓ} ( {A}^{( j )} , a ) = {E}_{a ∈ a} min {\sum }_{i} {α}_{i} ( ( {A}_{λ}^{( j )} , {⋃}_{i} {i}_{a}^{} ) , {i}_{a}^{} ) λ ∈ {Λ}^{( j )} .$$

From (Eq. 1), note that [symbol] is replaced by [symbol] since [symbol] (⋅, a) denotes the training [symbol] cost on fraction a of the dataset.

Assuming that all dataset sizes | [symbol] | are sufficiently large, and cross-validation is considered, it is reasonable to assume that the true loss function is smooth and convex in a (since loss functions are usually convex with respect to training data). Assume further that [symbol] has bounded second derivatives, i.e., [symbol] ″ (A^{(j)}, a)≤B, ∀a, ∀ A^{(j)}.

Let [symbol] (A^{(j)}, a) represent the training loss computed for algorithm A^{(j)} under FLASH, when using fraction a of the data. Note that [symbol] will in general differ from the true training loss [symbol] for several reasons: (i) The FL-HPO algorithm may calculate the HP sub-optimally; (ii) [symbol] (A^{(j)}, a) may be calculated over one (or a few) datasets [symbol] ∈ [symbol] instead of averaging over all possible datasets in [symbol] . Let σ represent the maximum difference between [symbol] (A^{(j)}, a) and [symbol] (A^{(j)}, a), i.e., | [symbol] (A^{(j)}, a)− [symbol] (A^{(j)}, a)|≤σ, ∀a, ∀ A^{(j)}. The value of σ depends on which of the three FL-HPO variants is used, and is discussed elsewhere herein. Finally, let δ be the minimum difference between the aₘ, i.e., δ=min{a₀, min_{m∈{1, . . . , M}}(aₘ−aₘ₋₁)}.

Loss Optimality Analysis: Let [symbol] * be the minimum training loss achievable, i.e., the minimum value of [symbol] (A^{(j)}, 1)across all algorithms A^{(j)}∈ [symbol] . In the following lemma, which is pertinent to bounding loss performance and training cost of embodiments of FLASH, the optimum algorithm refers to the one that attains the minimum training loss [symbol] *.

Lemma 1. If Δ>B+2σ+4σ/δ. FLASH ensures the training of the optimum algorithm (that attains [symbol] *) in every iteration m={0, . . . , M}.

Lemma 1 quantifies how large the tolerance parameter Δ needs to be so that the optimum algorithm is allocated data in every round. This leads to the following result, which shows in terms of training loss, embodiments of FLASH can be sub-optimal by at most 2σ, while advantageously providing substantial savings in communications costs.

Theorem 2. If Δ>B+2σ+4σ/δ, then the Alg-HP pair chosen by FLASH attains a training loss that is within α (for LKBM and RM) and 2σ (for LBM) of the minimum training loss, [symbol] *.

Training Cost Analysis. Bounding the degree of wasteful training, measured by the amount of training data allocated to sub-optimal algorithms is discussed next. Let ϵⱼ denote how sub-optimal algorithm A^{(j)} is, in terms of the training loss, i.e., ϵⱼ= [symbol] (A^{(j)}, 1)− [symbol] .

Theorem 3. If ϵⱼ≤B/2+2σ+4σ/6+Δ, then algorithm A^{(j)} receives the full dataset for training under FLASH; otherwise, the fraction of the training data allocated in rounds m≥4 by FLASH to any algorithm A^{(j)} is no more than max {0, 1−((ϵⱼ−B/2−2σ−4σ/δ−Δ)/(B/2))^{1/2}}.

Theorem 3 implies that the algorithms whose true training loss is within (B/2+2σ+4σ/δ+Δ) of [symbol] * receives full training; algorithms whose true training loss is beyond (B+2α+4α/δ+Δ) of [symbol] * do not receive any training data at all (except in the initial 3 rounds when all algorithms are trained). If their true training loss is within these two limits, then those sub-optimal algorithm incurs a training cost that decreases monotonically with ϵⱼ.

Bounding the Loss Calculation Error. We now proceed to bound α, as defined earlier, by computing an upper bound on | [symbol] (A^{(j)}, a)− [symbol] (A^{(j)}, a)| over all A^{(j)}, a values. To capture how the training loss rate for a given algorithm A^{(j)} varies with the distribution of the training dataset \hat{D}, define loss function \hat{l}(A^{(j)}, \hat{D}) as:

$$\hat{l} ( {A}^{( j )} , \hat{D} ) = min {\sum }_{i} {α}_{i} ( ( {A}_{λ}^{( j )} , {⋃}_{i} {\hat{D}}_{i} ) , {\hat{D}}_{i} ) for λ ∈ {Λ}^{( j )} .$$

For any algorithm A^{(j)}, and any two training datasets \hat{D}₁, \hat{D}₂, assume that \hat{l} satisfies |\hat{l}(A^{(j)}, \hat{D}₁)—\hat{l}(A^{(j)}, \hat{D}₂)|≤β⋅v(\hat{D}₁, \hat{D}₂), for some scalar constant β, with v being the 1-Wasserstein distance measure between the distributions of the two training datasets \hat{D}₁, \hat{D}₂. Further, let D^{a} denote the expectation of the distributions of all the datasets in [symbol] . Let dⱼ(⋅, ⋅) denote the 1-norm distance metric in Λ^{(j)}, the hyperparameter space of A^{(j)}. Further, let λₖⁱ, k∈[k]={1, . . . , κ} denote the κ HP choices of client i in RM. Define Dⱼ=Σᵢ aᵢ min_{k∈[κ]} dⱼ(λ, λₖⁱ), where min_{k∈[κ]} dⱼ(λ, λₖⁱ) determines the worst case distance of any HP in the space A^{(j)} from the closest initial HP chosen by client i. Let D̅ be an upper bound on Dⱼ ∀ⱼ.

The upper bound on σ depends on which FLASH variant is being used, and can be stated as follows:

Theorem 4. For the training dataset D^{a}, the loss calculation error for any algorithm A^{(j)} is upper-bounded by σ(a), given as σ(a)=β₀ v(D^{a}, D^{a})+\hat{σ}(a), where:

$$\hat{σ} ( a ) = {β}_{1} {\sum }_{i} {α}_{i} v ( {D}_{i}^{a} , {D}^{a} ) for LBM \\ \hat{σ} ( a ) = {β}_{2} {max}_{i , {i}^{′}} v ( {D}_{i}^{a} , {D}_{{i}^{′}}^{a} ) for LKBM \\ \hat{σ} ( a ) = {β}_{3} {\sum }_{i} {α}_{i} v ( {D}_{i}^{a} , {D}^{a} ) + γ \overline{D} for RM$$

for appropriately defined scalar constants β₀, β₁, β₂, β₃, and γ. Then σ is given by

$$σ = {max}_{a ∈ [ {a}_{0} , … , {a}_{m} ]} σ ( a ) .$$

In the above results, LKBM has been analyzed for the conservative case of K=1. Note that the bound for RM depends on κ (through D̅), the number of initial HPs chosen by each client, as it determines the accuracy of the HPO. The bounds are not directly comparable between the three FL-HPO models as the constants β1, β2, β3 can be different. However, a pertinent takeaway from the bounds is that the loss calculation errors (and therefore the overall loss performance bounds as computed by Theorem 2) depend on the dissimilarity between the client datasets. This results from the fact that in these FL-HPO approaches, the HPs (losses) are optimized (calculated) on the individual client datasets and then aggregated, instead of being computed globally.

### Empirical Evaluation

Dataset Selection: We initially selected 35 publicly available datasets with more than 10000 data-samples (the dataset sizes ranged from about 11 k to about 100 k). We split the datasets in a training part and validation part. We trained models using the training part and used accuracy on the validation part as performance metric. We considered seven well-performing known algorithms designated as KA1, KA2, KA3, KA4, KA5, KA6, and KA7, with well-defined HP space, for simulation. We define CASH-D and CASH-O as the validation accuracies found from the best performing algorithm (in terms of training accuracy) using known default HP settings, and with the optimized HP setting found through HPO, respectively. As expected, CASH-O attained better accuracy than CASH-D. However, 23 out of the 35 datasets showed very minor improvement, indicating that HPO does not yield much gain over the default HPs. However, we observed that the algorithm choice did have a significant impact on the performance.

From the remaining 12 datasets we selected 8 datasets referred to as DS1, DS2, DS3, DS4, DS5, DS6, DS7, and DS8 where CASH-O demonstrated higher gains and is diverse in terms of number of examples and features. We also considered the accuracy values attained by centrally solving the CASH problem with a known automated machine learning toolkit referred to herein as KAMLT. The higher accuracies attained by KAMLT compared to CASH-O in some cases is largely due to the fact that KAMLT spans a much larger algorithm set and HP space.

Baselines and Evaluation Metric: CASH-D and CASH-O are used as the performance evaluation baselines for FLASH for the 8 datasets that we selected. Define P_{D} and P* as the performance (accuracy) of CASH-D and CASH-O respectively for some dataset. For that same dataset, if FLASH attains accuracy P, define relative improvement with respect to CASH-D (CASH-O) as RI_{D} (RI*, respectively), respectively calculated as ((P-P_{D})/P_{D})×100% and ((P-P*)/P*)×100%. The RI reflects how much % improvement is achieved by FLASH compared to the centralized baselines. A negative RI value means that FLASH is performing worse than the baseline in that particular instance.

Implementation: exemplary embodiments of FLASH are implemented with two major loops (Algorithm 1), where the outer loop performs the algorithm selection and the inner loop performs FL-HPO (Algorithm 2). For each of the 8 datasets we selected, the generation of the client training and validation datasets was done as follows: first the dataset was randomly divided in N subsets, one for each client. Then, each client's dataset was divided into training and validation parts with a ratio of 70-30, using stratified sampling on the target class. Performance was measured as the average validation accuracy across clients. For training and evaluations, we used a known python library for hyperparameter optimization, a mainstream and easily configurable HPO algorithm, using 10-fold cross-validation. We also used different data seeds (which change the client data distributions) and different HPO seeds (which change the initial HP used by the known python library for hyperparameter optimization). Unless otherwise specified, each experiment was run 25 times with at different data and HPO seeds. Moreover, the value of aₘ in our empirical evaluation followed a geometric progression (not necessary for the theoretical analysis), implying aₘ=a₀·r^{m}. For the exemplary results, we used a₀=3.75% and a progression rate of r=1.5. While there can be other ways of choosing a₀, a₁, . . . , geometric progression was used because it is expected that the change of the slope will slow down for larger values of m.

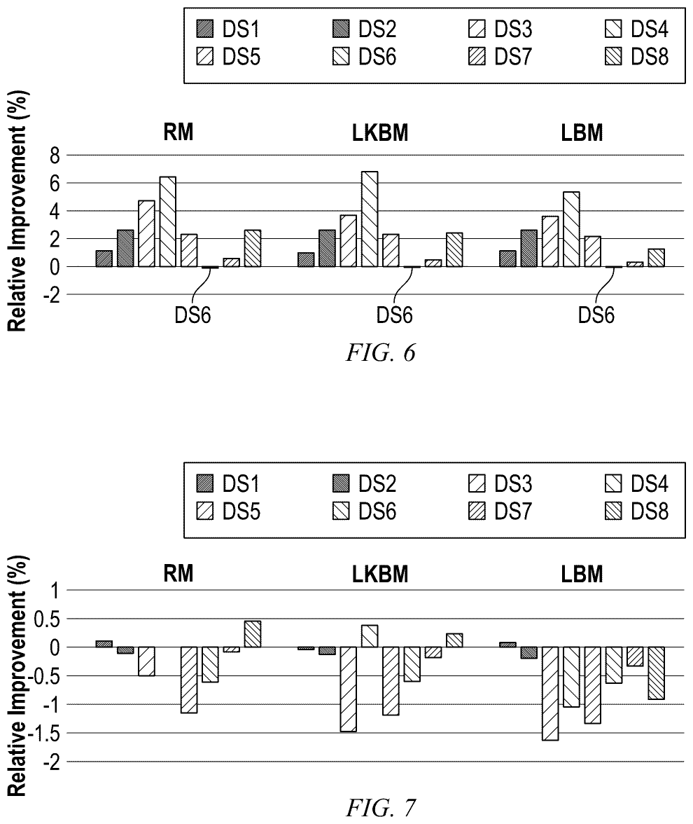

Comparison of different versions ofFLASH: first, experiments were performed on all 3 FL-HPO approaches (LBM, LKBM, RM) with Δ=0, N=3 clients, and HPOᵢₜₑᵣ=50 HPO iterations. The performance of all three exemplary variants of FLASH (LBM, LKBM, RM) was compared using their RI with respect to the baselines (i.e., CASH-D, CASH-O). FIG. 6 shows the value of RI when FLASH is compared to CASH-D. The improvement in performance with FLASH is quite prominent and for some datasets RI is as high as 5%. For the DS6 dataset the performance was decreased for some versions of FLASH, but that is less than 0.1%. Observe that all three variants of FLASH perform consistently while RM usually yields the best performance. This is a pertinent finding because it shows that FLASH which performs CASH on distributed client datasets performs better than an approach using optimal algorithm selection over default TPs and assuming all data is available at a central location.

FIG. 7 depicts the RI of FLASH compared to the CASH-O. In this case it is expected for FLASH to not yield improvement as CASH-O uses optimal algorithm selection and HPO on centralized data. The small negative RI values (up to −1.5%) indicate that FLASH is performing worse but very close to the centralized CASH-O solution. A few cases yield very small positive RI values (less than 0.5%) which indicate that FLASH slightly outperforms CASH-O, which sounds counter-intuitive. These cases arise due to over-fitting in the CASH-O model training which cause the depicted marginal decrease in validation accuracy. Of course, CASH-O always performs better than FLASH in terms of training accuracy (however, FLASH saves communication costs as compared to prior art techniques).

Run time for all the 3 variants of FL-HPO, normalized with respect to the average runtime of the slowest variant (RM), are provided in the table of FIG. 5. Although FLASH RM is usually the better performing FL-HPO technique, it does, however, consistently take the longest to run due to the additional regression analysis. Also, the communication overhead for FLASH RM and LKBM(not experimentally evaluated in this study) are twice that of LBM due to the re-evaluation. Moreover, the runtime for RM and LKBM tend to increase more than LBM with the increase of clients, possibly because of the re-evaluation done on the former two.

Consider now an ablation study to evaluate FLASH performance when Δ, N and HPOᵢₜₑᵣ are varied.

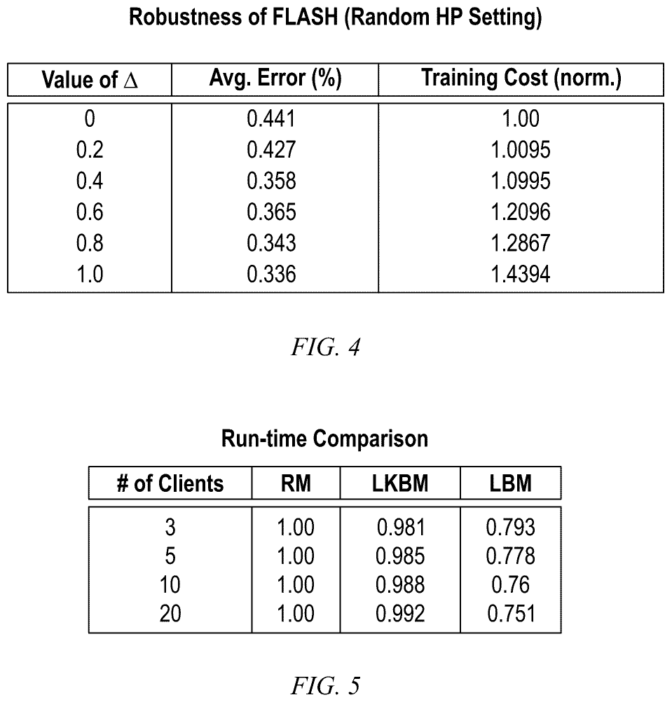

Impact of Tolerance Parameter (Δ): We ran FLASH for Δ ranging between 0 and 1. For each Δ, we performed 100 runs that included different data seed (client data distributions), HP seed (different initial HPs for known python library for hyperparameter optimization) and HPO iterations (HPOᵢₜₑᵣ). The table of FIG. 4 quantifies FLASH performance in terms of (%) average error (Avg. Error) and training cost. For each Δ, the Avg. Error is computed by averaging the difference between the accuracy of each run and the best accuracy over the 100 runs. The training cost is the ratio of the average training time of a Δ over the average training time of Δ=0 (training time increases with increased Δ), where average is taken over the 100 runs. We see that Δ=0 yields Avg. Error of 0.44%, which is very low and slightly higher than that of the higher Δs. Also training cost increases abruptly for Δ>0.6. Thus, Δ<0.6 seems best for exemplary embodiments and Δ=0 is a good value for the datasets we considered in our experiments. It should be noted that increasing Δ ensures a larger set of algorithms (having higher accuracy projection) to be trained at each round (m) and therefore a lower chance of picking a sub-optimal algorithm. Hence, with a higher Δ value, the average error decreases while the average training cost increases.

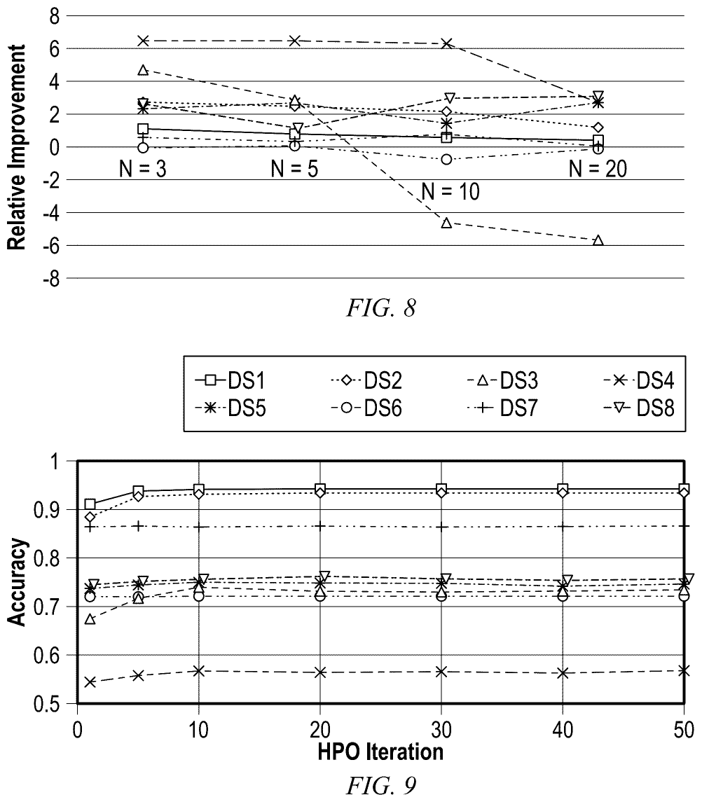

Impact of Number of Clients: FIG. 8 depicts the RI in performance for FLASH RM compared to CASH-D for different values of N. Notably, 6 of the 8 datasets showed very consistent results, with the RI values varying over a narrow range with variation in N. The performance decreases monotonically with increasing N for DS3 and shows a sharp drop at N=20 for DS4. However, upon close inspection of FIG. 8, some non-monotonic behavior is seen in the performance of FLASH RM. The overall performance of FLASH RM is impacted by factors such as: i) the amount of data per client and ii) the number of HP settings reported back to the central server to perform FL-HPO. In the empirical evaluation, the whole dataset was divided with equal data-samples per client, hence with larger N each client had fewer data-samples. Usually, less data per client leads to worse loss estimates, whereas with more HP settings reported (due to a larger number of clients), FLASH-RM is able to come up with better HP settings. Thus, there are two opposing forces in play here as N is increased, and it is not necessarily apparent under what conditions one factor would dominate the other.

Impact of Number of HPO iterations: The HPOᵢₜₑᵣ was varied from 1 to 50 on each client's dataset, and for FLASH RM the accuracy values are plotted against number of iteration in FIG. 9. Observe that accuracy in general increases when HPOᵢₜₑᵣ goes from 1 to 10 for FLASH RM (it takes a few more iterations for LBM and LKBM), after which it becomes almost flat (or increases slowly). Reaching the optimal solution in a few iterations justifies the use of the three proposed FL-HPO algorithms, especially in the case where HPO iterations at the clients are compute-intensive.

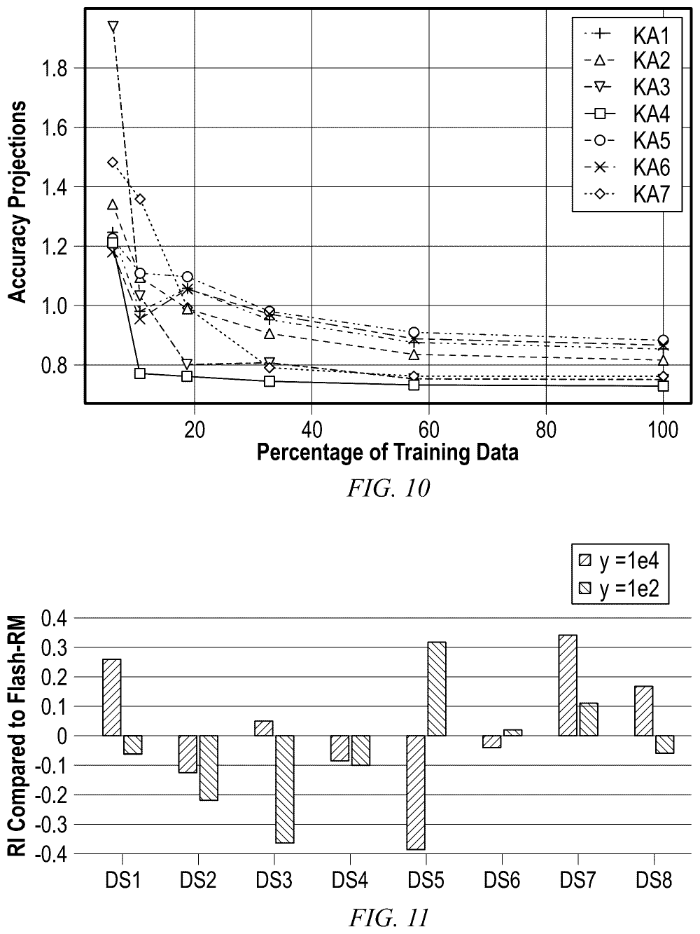

Accuracy projections with training data: To get more insight on how FLASH works, the projection of accuracy (analogous to the loss projection) for a specific dataset (DS2) is plotted versus percentage of training data in FIG. 10. It is worth noting that during the initial stages of FLASH, when the value of m is small (i.e., smaller training data), the KA3 and KA7 algorithms exhibit remarkably high accuracy projections. However, as the training progresses, their accuracy projections decline, while algorithms like KA5 and KA6 emerge as the frontrunners. Consequently, if FLASH had not reintroduced these algorithms in subsequent rounds and discarded them solely based on their initial performance, the overall accuracy would have been lower by 10%. These results use Δ=100%, so that the projection value of all the algorithms can be observed in each round.

Controlled heterogeneity. The impact of the degree of heterogeneity on FLASH performance will now be evaluated. In all of the aforementioned results, the label distributions of the clients were created by randomly dividing the entire dataset. Refer to FLASH with this random data distribution as FLASH-RANDOM. We create several client data distributions by controlling the heterogeneity of labels of the data points distributed to the clients using Dirichlet constant γ (smaller γ yields more heterogeneous non-iid distribution). FIG. 11 depicts the RI values of FLASH-RM for two values of γ (10² and 10⁴) over FLASH-RANDOM for data sets DS1-DS8. RI has a small range (−0.4% to 0.35%) for both values of γ across all datasets, demonstrating that FLASH performs consistently across heterogeneous non-iid distributions.

It will thus be appreciated that embodiments of FLASH solve the CASH problem in an FL setting by combining outer-level algorithm selection with inner-level FL-HPO methods, and requires the global FL model training problem to be solved only once, i.e., after the Alg-HP configuration has been selected. FLASH reduces training cost by allocating training data incrementally to only a subset of all algorithms based on their loss performances. Specifically, FLASH was theoretically analyzed and evaluated with three FL-HPO methods which are simple to implement, and the global HP and loss function was computed by aggregating those computed individually by the clients on their private data sets. Embodiments of FLASH are able to identify near optimal Alg-HP configuration with a few rounds of communication between the clients and the central server, and easy to implement in an FL environment. Extensive simulations show consistent and competitive performance of FLASH upon comparing it with centralized benchmarks.

It will thus be appreciated that one or more embodiments provide a FLASH framework which avoids FL trainings by using a proxy score compatible with the FL objective: for a given HP set, train and (cross-)validate at each party on it training dataset. Return scores to the aggregator. The aggregator computes a weighted average of these scores as a proxy score. For each algorithm, run an FL-HPO algorithm. Select the algorithm and its hyperparameters with the highest proxy score. To reduce FL-HPO complexity being run on entire local datasets for all algorithms, use a multi-fidelity optimization approach, where increased fractions of the local datasets are allocated to the best algorithms based on a projected score curve. Return the algorithm and hyper-parameter set that survives until the full local dataset size.

One or more embodiments decompose the CASH problem into two-levels: Algorithm Selection (AS) (outer level) and FL-HPO (inner level). In the outer-level AS problem, training data is allocated incrementally in rounds, only to the best performing algorithms (according to their projected performance, but with a tolerance parameter Δ). This advantageously saves training costs, as poorly performing algorithms do not need to be trained on full data (i.e., they are weeded out early). In the inner-level HPO problem, HPO for the algorithm(s) in that round is performed in a federated manner. Each client solves the HPO locally, and provides the best HP(s) and their local loss rates to the central server. The central server aggregates the local HPs and their losses to find the global HP (possibly after re-validation). Three non-limiting exemplary variants are disclosed: Local Best Model (LBM), Local K-Best Model (LKBM) and Regression based Model (RM).

One or more embodiments thus provide a method to perform training algorithm selection and hyperparameter tuning in a federated learning system including an aggregator and multiple clients with local datasets for training a global model. The aggregator receives as input a set of candidate training algorithms and an initial dataset fraction number between zero and one. The aggregator sends an HPO query to the clients containing a dataset fraction number and all candidate training algorithms. Each client uses the query input to determine an optimal set of hyper-parameters for each training algorithm on a fraction of its local dataset equal to the received dataset fraction number. The clients send their optimal hyper-parameters and scores to the aggregator for the given algorithms and data fraction number. The aggregator aggregates the transmitted scores to a single score value and uses it to update a projected score curve for each algorithm. The aggregator selects a subset of the algorithms with the highest score predicted by the projected score curve. The aggregator sends an HPO query to the clients containing the selected subset of training algorithms and an increased fraction number. The aggregator and clients repeating the above steps until the dataset fraction number reaches 100%. The aggregator and clients then train a federated global model using the best algorithm and hyperparameters.

In one or more embodiments, the local dataset of each client is split into a training part and validation part.

In some cases, each client receives the HPO query and uses its local dataset for each training algorithm to run an HPO algorithm to generate a set of hyperparameters and scores, and sends the set to the aggregator.

In one or more embodiments, the aggregator uses the collected hyperparameters and scores to select the best global hyperparameters for FL training, and shares them with all clients

The score can be any ML metric, including, for example, accuracy or loss.

In some instances, the aggregator aggregating the transmitted scores to a single score value can be done with a linear or non-linear combining of the transmitted scores.

In some embodiments, the projection curve for each training algorithm is generated using non-linear or linear interpolation based on the history of client scores of different dataset fractions

In some cases, the aggregator selecting a subset of the algorithms with highest score predicted by the projected score curve is done based on a tolerance parameter Δ, where all algorithms within Δ from the highest score are selected for HPO on the next increased data fraction.

The HPO algorithms can be, for example, random search, Bayesian algorithms, and the like.

It is worth noting that one or more embodiments advantageously include algorithm selection along with Hyper-Parameter Optimization (HPO), and do not need any Federated Learning (FL) in the Algorithm selection or the HPO stage; rather FL is used in one or more embodiments after the best Algorithm and HP set is found (e.g., “one shot” FL). This provides the benefit of a decentralized approach for automated determination of best hyper-parameters as well as algorithm selection in the context of Federated Learning.

In one or more embodiments the clients can perform HPO themselves using any HPO technique and report the performance to the central server.

In one or more embodiments, a master model is trained only once after the Algorithm selection and HPO is done. The algorithm selection and HPO in one or more embodiments is done in a decentralized (no data communication between clients) way without any FL, and finally the master model is trained with one shot FL (using the optimized algorithm and HPs).

### Recapitulation

Given the discussion thus far, it will be appreciated that, in general terms, an exemplary method, according to an aspect of the invention, includes the steps of for at least a first two iterations: for a plurality of candidate training algorithms (e.g., Algorithm 1, line 4), obtaining, at a federated learning aggregator, from each of a plurality of federated learning clients, a score corresponding to a best hyperparameter, based on a fraction of available training data (see, e.g., Algorithm 1, line 9); for the plurality of candidate algorithms, the federated learning aggregator aggregating the obtained scores and updating a projected score for each of the candidate training algorithms; and increasing the fraction of available training data to be used in a subsequent one of the at least a first two iterations or a first one of a plurality of subsequent iterations. Regarding the aggregation of the obtained scores, refer, for example, to Algorithm 1, line 11. In one or more embodiments, the fraction of data is being increased from, say, a₀ to a₁ to a₂ in the case of three iterations. In a non-limiting example, a₀ is 10%, a₁ is 20%, a₂ is 30% and so on until aₘ is 100%. Other embodiments can use other values which could, for example, be determined heuristically by the skilled artisan, dependent on the domain, given the teachings herein. In one or more embodiments, the first group of iterations (at least the first two and in the specific example of FIG. 2 Algorithm 1, the first three (line 3, m<4)) are carried out for progressively larger fractions of data for ALL candidate algorithms (line 4).

In one or more embodiments, the method further includes, for the plurality of subsequent iterations: for a best-performing subset of the plurality of candidate training algorithms, obtaining, at the federated learning aggregator, from each of the plurality of federated learning clients, an updated best hyperparameter and an updated corresponding score, based on a further increased fraction of available training data as compared respectively to a final iteration of at least first two iterations or a previous one of the subsequent iterations (e.g., Algorithm 1, line 9) and for the best-performing subset of the plurality of candidate algorithms, the federated learning aggregator aggregating the obtained updated scores and further updating a projected score for each of the best-performing subset of the candidate training algorithms (e.g., Algorithm 1, line 11).

Regarding the best performing subset, see. e.g., Algorithm 1, line 6). Generally regarding the subsequent iterations, these are the iterations subsequent to the at least first two iterations (in the non-limiting example of FIG. 2, (Algorithm 1, m≥4). In one or more embodiments, the subsequent group of iterations are carried out for progressively larger fractions of data for the best performing subset of candidate algorithms.

One or more embodiments further include the aggregator communicating with the clients to cooperatively train a federated global model based on a best one of the best-performing subset of the candidate training algorithms and its corresponding hyperparameters. For example, train based on Algorithm 1, lines 15 and 16. Stated in another way, use the best performing algorithm in the final iteration along with the best hyperparameters found in the final iteration for that algorithm as the algorithm-hyperparameter combination to be used in federated training.

In one or more embodiments, the plurality of subsequent iterations are continued until the fraction of available training data reaches 100%. In one or more embodiments, M is such that the fraction of data at a_{M}=100%.

Once the federated global model is trained, one or more embodiments further include carrying out inferencing with the trained federated global model.

The training and inferencing as described herein are believed to be particularly advantageous when the clients are thin clients and/or when the network(s) connecting the clients with the aggregator has/have limited bandwidth. For example, the network(s) could be less than Gigabit Ethernet, less than wireless 802.11n (600 Mbps), less than Fast Ethernet (100 Mbps), less than wireless 802.11g (54 Mbps), or even less than traditional Ethernet (10 Mbps).

As noted, in a preferred but non-limiting example, the at least first two iterations are the first three iterations.

Referring, for example, to the discussion of LBM in Algorithm 2 of FIG. 3, one or more embodiments further include the federated learning aggregator aggregating the obtained updated scores and further updating a projected score for each of the best-performing subset of the candidate training algorithms comprises one of max voting and averaging a best hyperparameter setting of each of the clients.

Referring, for example, to the discussion of LKBM in Algorithm 2 of FIG. 3, one or more embodiments further include the federated learning aggregator aggregating the obtained updated scores and further updating a projected score for each of the best-performing subset of the candidate training algorithms comprises taking a union of a top K hyperparameter settings of each of said clients, which is sent for re-evaluation.

Referring, for example, to the discussion of RM in Algorithm 2 of FIG. 3, one or more embodiments further include the federated learning aggregator aggregating the obtained updated scores and further updating a projected score for each of the best-performing subset of the candidate training algorithms comprises performing regression using hyperparameters from each of the clients and their losses to generate top-K hyperparameter settings for re-evaluation.

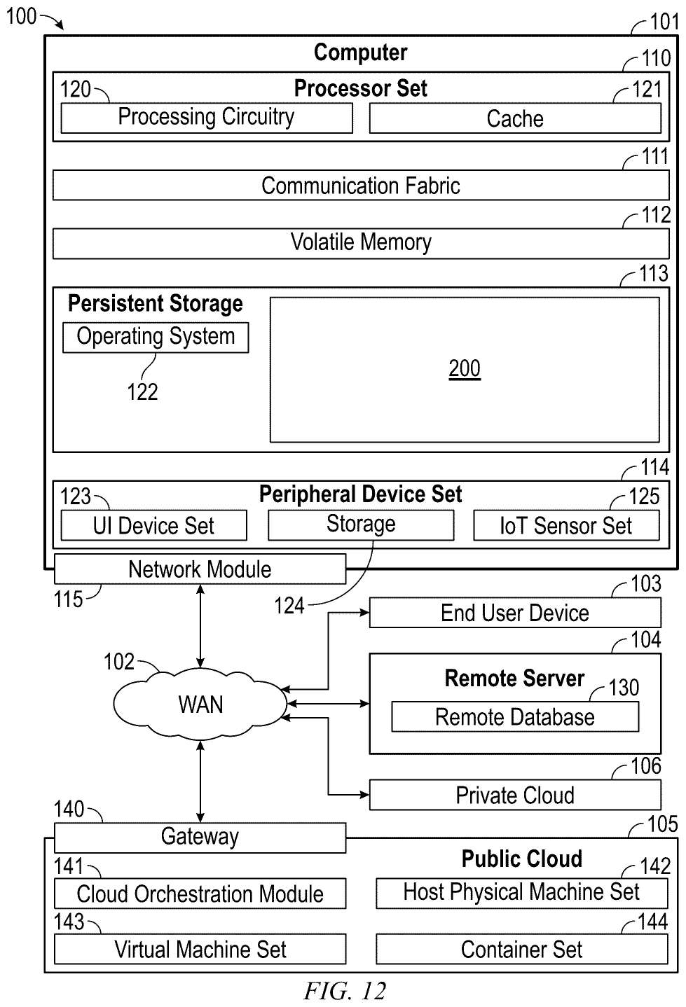

In another aspect, an exemplary computer program product is provided for implementing a federated learning aggregator on a computer. See, for example, discussion of FIG. 12 below. The aggregator can perform any one, some, or all of the steps described herein.

In still another aspect, a federated learning aggregator includes: a memory; and at least one processor, coupled to the memory. The at least one processor is operative to perform any one, some, or all of the steps described herein. See, for example, discussion of FIG. 12 below.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 12.

Computing environment 100 contains an example of an environment for the execution of at least some of the computer code involved in performing the inventive methods, as seen at 200 (e.g., federated learning software implementing aspects of the invention on an aggregator 301 or client 303 as the case may be). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 12. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 12 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
for at least a first two iterations:
for a plurality of candidate training algorithms, obtaining, at a federated learning aggregator, from each of a plurality of federated learning clients, a score corresponding to a best hyperparameter, based on a fraction of available training data;
for the plurality of candidate algorithms, the federated learning aggregator aggregating the obtained scores and updating a projected score for each of the candidate training algorithms; and
increasing the fraction of available training data to be used in a subsequent one of the at least a first two iterations or a first one of a plurality of subsequent iterations;
for the plurality of subsequent iterations:
for a best-performing subset of the plurality of candidate training algorithms, obtaining, at the federated learning aggregator, from each of the plurality of federated learning clients, an updated best hyperparameter and an updated corresponding score, based on a further increased fraction of available training data as compared respectively to a final iteration of at least first two iterations or a previous one of the subsequent iterations; and
for the best-performing subset of the plurality of candidate algorithms, the federated learning aggregator aggregating the obtained updated scores and further updating a projected score for each of the best-performing subset of the candidate training algorithms.

2. The method of claim 1, further comprising the aggregator communicating with the clients to cooperatively train a federated global model based on a best one of the best-performing subset of the candidate training algorithms and its corresponding hyperparameters.

3. The method of claim 2, wherein the plurality of subsequent iterations are continued until the fraction of available training data reaches 100%.

4. The method of claim 2, further comprising carrying out inferencing with the trained federated global model.

5. The method of claim 4, wherein the clients comprise thin clients.

6. The method of claim 1, wherein the at least first two iterations comprise a first three iterations.

7. The method of claim 1, wherein the federated learning aggregator aggregating the obtained updated scores and further updating a projected score for each of the best-performing subset of the candidate training algorithms comprises one of max voting and averaging a best hyperparameter setting of each of the clients.

8. The method of claim 1, wherein the federated learning aggregator aggregating the obtained updated scores and further updating a projected score for each of the best-performing subset of the candidate training algorithms comprises taking a union of a top K hyperparameter settings of each of said clients, which is sent for re-evaluation.

9. The method of claim 1, wherein the federated learning aggregator aggregating the obtained updated scores and further updating a projected score for each of the best-performing subset of the candidate training algorithms comprises performing regression using hyperparameters from each of the clients and their losses to generate top-K hyperparameter settings for re-evaluation.

10. A computer program product for implementing a federated learning aggregator on a computer, the computer program product comprising:
a computer readable storage medium having stored thereon:
first program instructions executable by the computer to cause the computer to, for at least a first two iterations:
for a plurality of candidate training algorithms, obtaining, at a federated learning aggregator, from each of a plurality of federated learning clients, a score corresponding to a best hyperparameter, based on a fraction of available training data;
for the plurality of candidate algorithms, the federated learning aggregator aggregating the obtained scores and updating a projected score for each of the candidate training algorithms; and
increasing the fraction of available training data to be used in a subsequent one of the at least a first two iterations or a first one of a plurality of subsequent iterations; and
second program instructions executable by the computer to cause the computer to, for the plurality of subsequent iterations:
for a best-performing subset of the plurality of candidate training algorithms, obtaining, at the federated learning aggregator, from each of the plurality of federated learning clients, an updated best hyperparameter and an updated corresponding score, based on a further increased fraction of available training data as compared respectively to a final iteration of at least first two iterations or a previous one of the subsequent iterations; and
for the best-performing subset of the plurality of candidate algorithms, the federated learning aggregator aggregating the obtained updated scores and further updating a projected score for each of the best-performing subset of the candidate training algorithms.

11. The computer program product of claim 10, further comprising third program instructions executable by the computer to cause the computer implementing the federated learning aggregator to communicate with the clients to cooperatively train a federated global model based on a best one of the best-performing subset of the candidate training algorithms and its corresponding hyperparameters.

12. The computer program product of claim 11, wherein the plurality of subsequent iterations are continued until the fraction of available training data reaches 100%.

13. A federated learning aggregator comprising:
a memory; and
at least one processor, coupled to the memory, and operative to:
for at least a first two iterations:
for a plurality of candidate training algorithms, obtain from each of a plurality of federated learning clients, a score corresponding to a best hyperparameter, based on a fraction of available training data;
for the plurality of candidate algorithms, aggregate the obtained scores and update a projected score for each of the candidate training algorithms; and
increase the fraction of available training data to be used in a subsequent one of the at least a first two iterations or a first one of a plurality of subsequent iterations;
for the plurality of subsequent iterations:
for a best-performing subset of the plurality of candidate training algorithms, obtain, from each of the plurality of federated learning clients, an updated best hyperparameter and an updated corresponding score, based on a further increased fraction of available training data as compared respectively to a final iteration of at least first two iterations or a previous one of the subsequent iterations; and
for the best-performing subset of the plurality of candidate algorithms, aggregate the obtained updated scores and further update a projected score for each of the best-performing subset of the candidate training algorithms.

14. The federated learning aggregator of claim 13, wherein the at least one processor is further operative to communicate with the clients to cooperatively train a federated global model based on a best one of the best-performing subset of the candidate training algorithms and its corresponding hyperparameters.

15. The federated learning aggregator of claim 14, wherein the plurality of subsequent iterations are continued until the fraction of available training data reaches 100%.

16. The federated learning aggregator of claim 14, wherein the at least one processor is further operative to carry out inferencing with the trained federated global model.

17. The federated learning aggregator of claim 13, wherein the at least first two iterations comprise a first three iterations.

18. The federated learning aggregator of claim 13, wherein the federated learning aggregator aggregating the obtained updated scores and further updating a projected score for each of the best-performing subset of the candidate training algorithms comprises one of max voting and averaging a best hyperparameter setting of each of the clients.

19. The federated learning aggregator of claim 13, wherein the federated learning aggregator aggregating the obtained updated scores and further updating a projected score for each of the best-performing subset of the candidate training algorithms comprises taking a union of a top K hyperparameter settings of each of said clients, which is sent for re-evaluation.

20. The federated learning aggregator of claim 13, wherein the federated learning aggregator aggregating the obtained updated scores and further updating a projected score for each of the best-performing subset of the candidate training algorithms comprises performing regression using hyperparameters from each of the clients and their losses to generate top-K hyperparameter settings for re-evaluation.
